(19) United States
(12) Patent Application Publication
(10) Pub. No.: US 2026/0106668 A1
(43) Pub. Date: Apr. 16, 2026

(54) METROLOGY SYSTEM

(71) Applicant: Applied Materials, Inc., Santa Clara, CA (US)

(72) Inventors: Haoran WANG, Sunnyvale, CA (US); Jinxin FU, Fremont, CA (US); Daihua ZHANG, Los Altos, CA (US); Yangyang SUN, San Jose, CA (US); Ludovic GODET, Sunnyvale, CA (US)

(21) Appl. No.: 19/341,004

(22) Filed: Sep. 26, 2025

Related U.S. Application Data
(60) Provisional application No. 63/706,932, filed on Oct. 14, 2024.

(51) Int. Cl. H04B 10/071

(52) U.S. Cl. CPC H04B 10/071

(57) ABSTRACT

The present disclosure describes a metrology system. The system includes a an optical source, a first sensor, and a second sensor. The optical source is positioned on a first side of an optical device held by a stage. The first sensor is positioned on the first side of the optical device. During a first mode, the first sensor detects a first optical signal from the optical source reflected from the optical device. During a second mode, the second sensor moves such that (i) the second sensor is positioned on a second side of the optical device opposite the first side of the optical device and (ii) the second sensor detects a second optical signal from the optical source transmitted through the optical device.

### CROSS-REFERENCE TO RELATED APPLICATIONS

This Application claims the benefit of U.S. Provisional Application 63/706,932 filed on Oct. 14, 2024, which is incorporated by reference in its entirety.

### BACKGROUND

### Field

Embodiments of the present disclosure generally relate to optical devices for augmented, virtual, and mixed reality. More specifically, embodiments described herein relate to a metrology system for measuring these optical devices.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality provides an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is measuring optical devices (e.g., the display lenses of the glasses) for image quality standards. To determine whether image quality standards are met, metrology metrics of the fabricated optical devices may be measured using a metrology system.

### SUMMARY

The present disclosure describes a metrology system. The system includes a an optical source, a first sensor, and a second sensor. The optical source is positioned on a first side of an optical device held by a stage. The first sensor is positioned on the first side of the optical device. During a first mode, the first sensor detects a first optical signal from the optical source reflected from the optical device. During a second mode, the second sensor moves such that (i) the second sensor is positioned on a second side of the optical device opposite the first side of the optical device and (ii) the second sensor detects a second optical signal from the optical source transmitted through the optical device.

According to another embodiment, a method includes, during a first mode, directing, by an optical source positioned on a first side of an optical device held by a stage, a first optical signal towards the optical device, and detecting, by the first sensor, the first optical signal from the optical source reflected from the optical device. The method further includes, during a second mode, directing, by the optical source, a second optical signal towards the optical device and moving a second sensor such that (i) the second sensor is positioned on a second side of the optical device opposite the first side of the optical device and (ii) the second sensor detects the second optical signal from the optical source transmitted through the optical device.

According to another embodiment, a non-transitory computer readable medium stores instructions that, when executed by one or more processors, causes the one or more processors to, individually or collectively, during a first mode, direct, by an optical source positioned on a first side of an optical device held by a stage, a first optical signal towards the optical device, and detect, by the first sensor, the first optical signal from the optical source reflected from the optical device. The instructions further cause the one or more processors to, individually or collectively, during a second mode, direct, by the optical source, a second optical signal towards the optical device and move a second sensor such that (i) the second sensor is positioned on a second side of the optical device opposite the first side of the optical device and (ii) the second sensor detects the second optical signal from the optical source transmitted through the optical device.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a metrology system;

FIGS. 2A through 2F illustrate an example operation of the metrology system of FIG. 1.

FIG. 3A illustrates an example optical device in the metrology system of FIG. 1.

FIG. 3B illustrates an example portion of the metrology system of FIG. 1.

FIG. 4 illustrates an example operation performed by the metrology system of FIG. 1.

FIG. 5 is a flowchart of an example method performed by the metrology system of FIG. 1.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

A metrology system may be used to measure metrology metrics of optical devices (e.g., glass lenses) to determine whether the optical devices meet image quality standards. In existing implementations, separate metrology systems are used to measure transmission metrics that indicate how optical signals transmit through an optical device and to measure reflection metrics that indicate how optical signals reflect off the optical device. Separate metrology systems, however, occupy a large area and typically, complex structures are used to move optical devices between the separate metrology systems.

The present disclosure describes a metrology system that measures both transmission metrics and reflection metrics. The metrology system includes a first sensor that detects optical signals reflected off an optical device. In a first mode (which may be referred to as a reflection mode), the optical device may be moved into position such that the first sensor is positioned on a first side of the optical device (e.g., above the optical device), and an optical source directs an optical signal towards the optical device. The optical signal reflects off the optical device, and the system moves the first sensor to detect the optical signal and to measure reflection metrics. A second mode (which may be referred to as a transmission mode) begins after the first mode. The system moves a second sensor that detects optical signals transmitted through the optical device such that the second sensor is positioned on a second side of the optical device (e.g., beneath the optical device). The optical source directs an optical signal towards the optical device, and the optical signal passes through the optical device. They system moves the second sensor to detect the optical signal and to measure transmission metrics. After the second mode concludes, the system moves the second sensor away from the optical device so that the optical device may be moved away or out of the system.

In certain embodiments, the system provides several technical advantages. For example, the system measures both reflection metrics and transmission metrics. As a result, the system occupies less area than a set of multiple systems that measure reflection metrics and/or transmission metrics. As another example, the system may reduce the amount of time it takes to measure reflection metrics and transmission metrics by removing the need to shuttle optical devices between multiple systems that measure reflection metrics and/or transmission metrics.

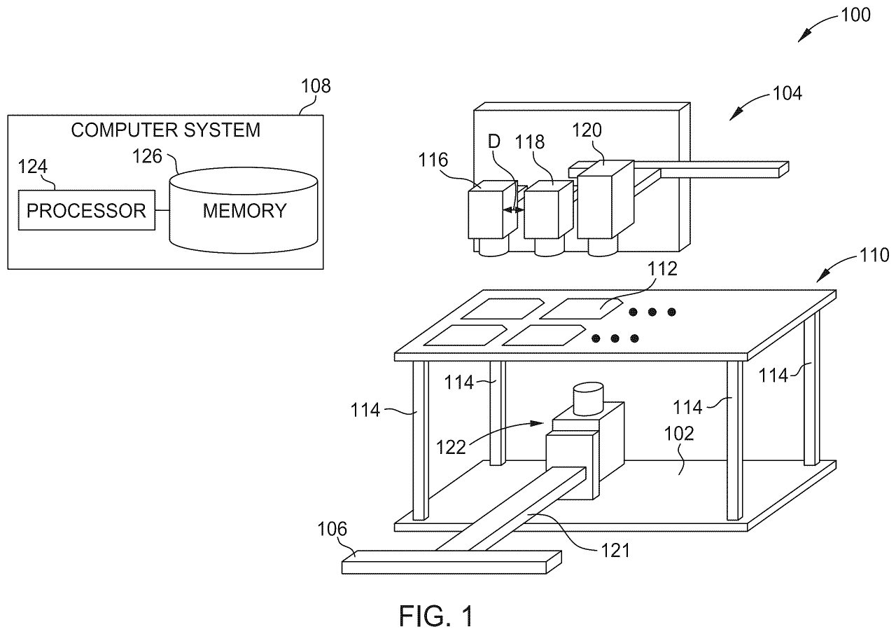

FIG. 1 illustrates an example metrology system 100. As seen in FIG. 1, the metrology system includes a stage 102, an upper portion 104, a bottom portion 106, and a computer system 108. Generally, the metrology system 100 measures both reflection metrics and transmission metrics of optical devices (e.g., lenses for augmented reality systems). For example, the metrology system 100 may measure or determine angular uniformity, contrast, efficiency, color uniformity, modulation transfer function curve, field of view, ghost images, eye box, display leakage, and/or see through test metrics for an optical device.

The stage 102 holds or elevates optical devices. As seen in FIG. 1, the stage 102 supports a tray 110. In some embodiments, the stage 102 supports a wafer instead of or in addition to the tray 110. Multiple optical devices 112 are positioned on the tray 110. These optical devices 112 may be lenses for augmented reality and/or virtual reality systems. The stage 102 includes columns 114 that elevate the tray 110 and that create a space between the tray 110 and a bottom surface of the stage 102. During operation, the system 100 may move the stage 102 to position the optical devices 112 relative to the upper portion 104 and/or the bottom portion 106. The system 100 may also move the stage 102 to shuttle the optical devices 112 into and out of the metrology system 100. In some instances, the stage 102 is considered to hold the optical devices 112 when the optical devices 112 are supported by the tray 110.

The upper portion 104 is positioned on a first side of the optical devices 112 (e.g., above the optical devices 112). As seen in FIG. 1, the upper portion 104 includes an alignment camera 116, an optical source 118, and a sensor 120. The alignment camera 116 and the optical source 118 may be laterally separated by a distance D. In some embodiments, the distance D between the alignment camera 116 and the optical source 118 is fixed and known by the system 100.

The alignment camera 116 captures images of the optical devices 112, and the system 100 may use these images to position the optical devices 112 relative to the upper portion 104 and/or the bottom portion 106. For example, these images may be used to position the optical devices 112 so that the optical device 112 directs optical signals towards the optical devices 112. In some embodiments, the optical devices 112 include fiducials (e.g., markings, slits, etc.). The images of the optical devices 112 show these fiducials, and the metrology system 100 uses the fiducials to determine how to move (e.g., translate, rotate, etc.) the stage 102 to properly position the optical devices 112 for the upper portion 104 and/or the bottom portion 106.

In some embodiments, the metrology system 100 uses the distance D between the alignment camera 116 and the optical source 118 to determine how to properly position the optical device 112. For example, the metrology system 100 may determine the positioning of the optical device 112 relative to the alignment camera 116 using the images from the alignment camera 116. The metrology system 100 then uses the distance D to determine how to position the optical device 112 relative to the alignment camera 116 such that an optical signal from the optical source 118 reaches the optical device 112. The metrology system 100 then moves the stage 102 to reposition the optical device 112.

The optical source 118 produces and directs optical signals towards the optical devices 112. By adjusting the position or orientation of an optical device 112 relative to the optical source 118 (e.g., by moving the stage 102), the metrology system 100 may control whether an optical signal from the optical source 118 reflects off the optical device 112 or transmits through the optical device 112.

The sensor 120 may detect optical signals that reflect off the optical device 112. For example, the metrology system 100 may move the sensor 120 until the sensor 120 detects the optical signal produced by the optical source 118 and reflecting off the optical device 112. The metrology system 100 may then analyze the signals from the sensor 120 to determine reflection metrics for the optical device 112.

The bottom portion 106 includes an arm 121 and a sensor 122 attached to the arm 121. Generally, after the metrology system 100 measures the reflection metrics using the sensor 120, the metrology system 100 moves the arm 121 to position the sensor 122 on a second side of the optical device 112 (e.g., beneath the optical device 112). As seen in FIG. 1, the metrology system 100 may move the arm 121 such that the sensor 122 is positioned between the stage 102 and the optical device 112. The metrology system 100 may also move the stage 102 to position or orient the optical device 112 such that the optical device 112 transmits an optical signal produced by the optical source 118 and directed towards the optical device 112.

The metrology system 100 then moves the sensor 122 (e.g., by moving the arm 121) so that the sensor 122 detects the optical signal produced by the optical source 118 and transmitted through the optical device 112. The metrology system 100 may then analyze the signals from the sensor 122 to determine transmission metrics for the optical device 112. After the metrology system 100 measures the transmission metrics using the sensor 122, the metrology system 100 moves the arm 121 away from the optical device 112 and the stage 102 such that the bottom portion 106 does not collide with one or more of the columns 114 when the metrology system 100 moves the stage 102 and the optical device 112 away from or out of the metrology system 100. After the metrology system 100 moves the stage 102 and the optical device 112 away from or out of the metrology system 100, the metrology system 100 may move another stage elevating additional optical devices into the metrology system 100 for measurement.

The computer system 108 controls the operation of the metrology system 100. For example, the computer system 108 may control the movement of the stage 102, the sensor 120, and/or the sensor 122. As seen in FIG. 1, the computer system 108 includes a processor 124 and a memory 126, which perform the functions or features of the computer system 108 described herein.

The processor 124 is any electronic circuitry, including, but not limited to one or a combination of microprocessors, microcontrollers, application specific integrated circuits (ASIC), application specific instruction set processor (ASIP), and/or state machines, that communicatively couples to the memory 126 and controls the operation of the computer system 108. The processor 124 may be 8-bit, 16-bit, 32-bit, 64-bit or of any other suitable architecture. The processor 124 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 124 may include other hardware that operates software to control and process information. The processor 124 executes software stored on the memory 126 to perform any of the functions described herein. The processor 124 controls the operation and administration of the computer system 108 by processing information (e.g., information received from the alignment camera 116, sensor 120, sensor 122, and memory 126). The processor 124 is not limited to a single processing device and may encompass multiple processing devices contained in the same device or computer or distributed across multiple devices or computers. The processor 124 is considered to perform a set of functions or actions if the multiple processing devices collectively perform the set of functions or actions, even if different processing devices perform different functions or actions in the set.

The memory 126 may store, either permanently or temporarily, data, operational software, or other information for the processor 124. The memory 126 may include any one or a combination of volatile or non-volatile local or remote devices suitable for storing information. For example, the memory 126 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 126, a disk, a CD, or a flash drive. In particular embodiments, the software may include an application executable by the processor 124 to perform one or more of the functions described herein. The memory 126 is not limited to a single memory and may encompass multiple memories contained in the same device or computer or distributed across multiple devices or computers. The memory 126 is considered to store a set of data, operational software, or information if the multiple memories collectively store the set of data, operational software, or information, even if different memories store different portions of the data, operational software, or information in the set.

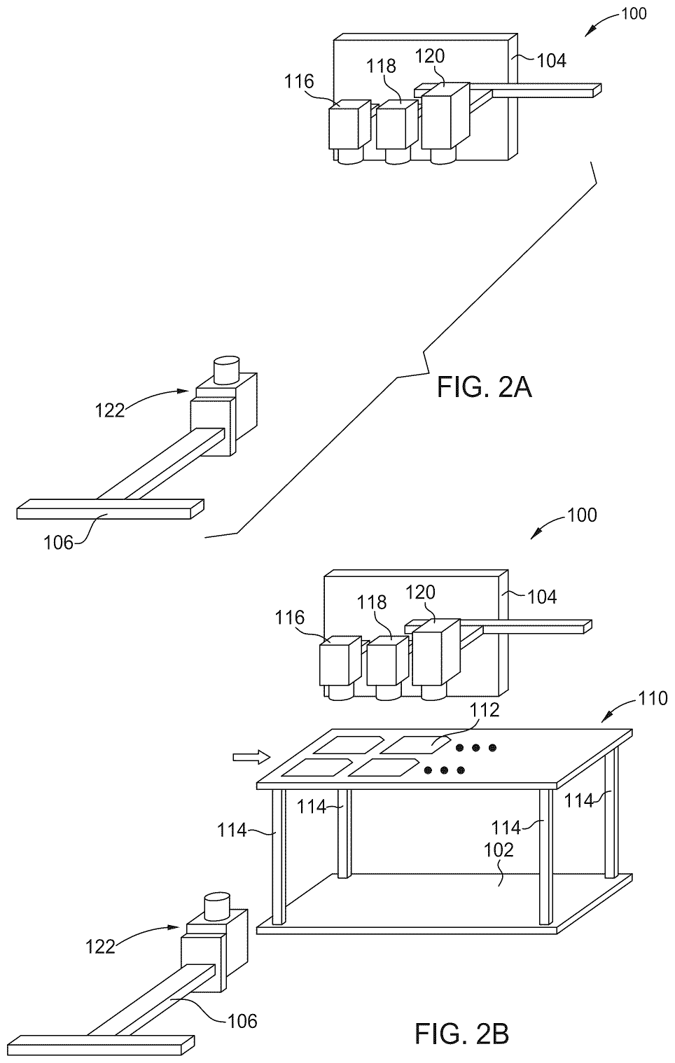

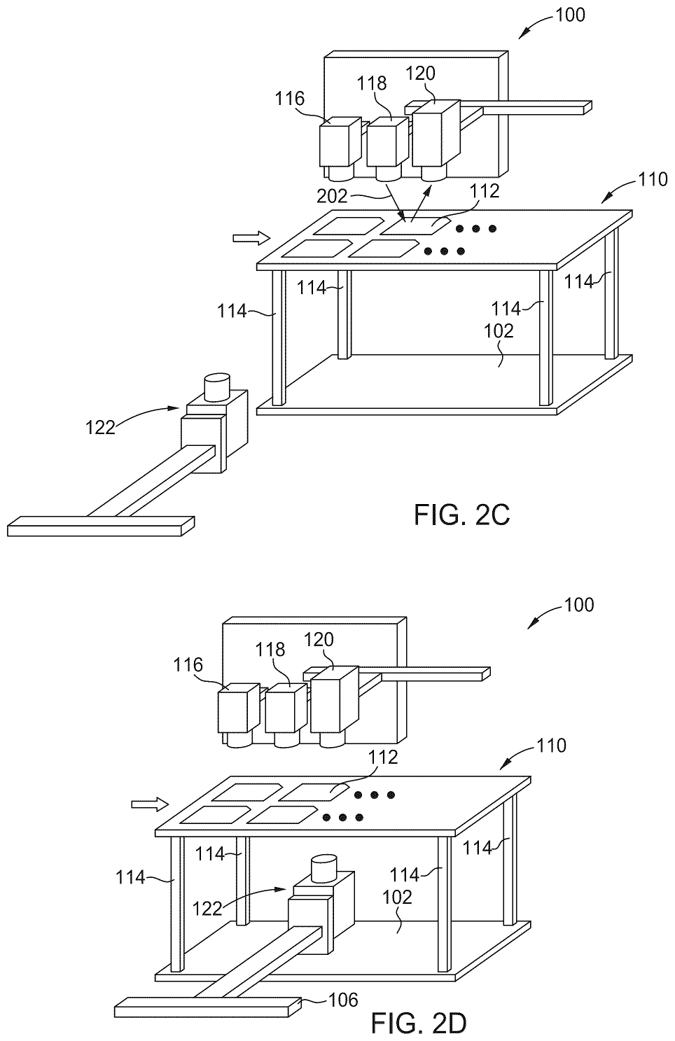

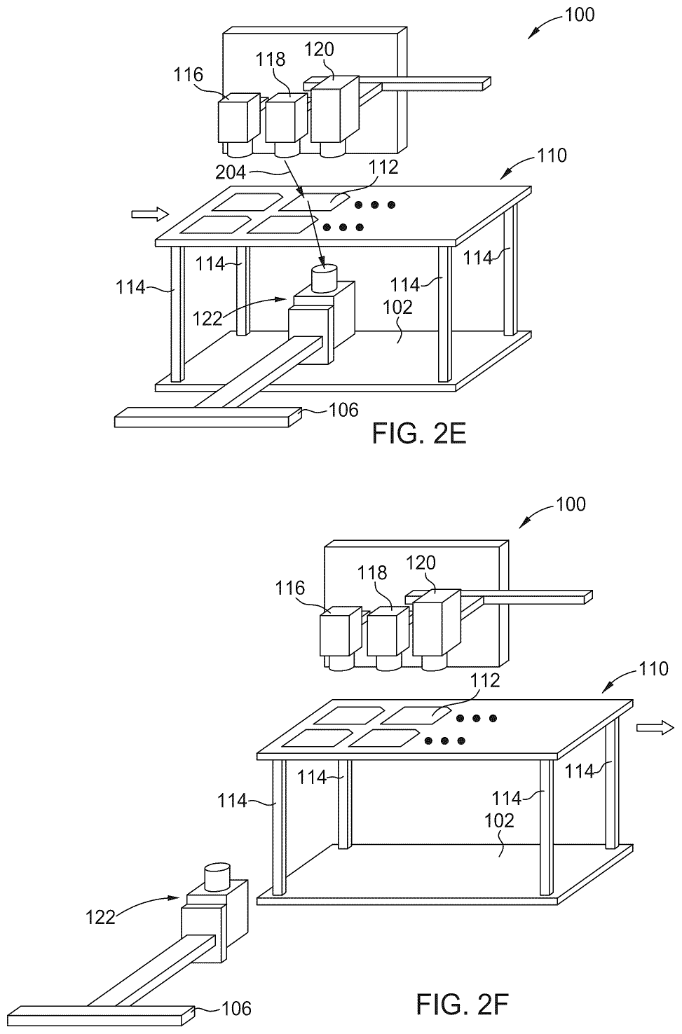

FIGS. 2A through 2F illustrate an example operation of the metrology system 100 of FIG. 1. As seen in FIG. 2A, the metrology system 100 begins with the bottom portion 106 moved away from the upper portion 104 such that there is a gap into which a stage elevating an optical device may move. As seen in FIG. 2B, the metrology system 100 moves a stage 102 into the gap. The stage 102 elevates a tray 110 and an optical device 112, and the upper portion 104 is positioned above the optical device 112. The alignment camera 116 may capture an image of the optical device 112. The metrology system 100 may use the image to determine how to position the optical device 112 such that an optical signal from the optical source 118 is directed at the optical device 112 and such that the optical device 112 reflects the optical signal. In some embodiments, the metrology system 100 also uses the distance between the alignment camera 116 and the optical source 118 to determine how to position the optical device 112. The metrology system 100 then moves (e.g., translates, rotates, etc.) the stage 102 to position the optical device 112.

As seen in FIG. 2C, the optical source 118 directs an optical signal 202 towards the optical device 112, and the optical signal 202 reflects off the optical device 112. The metrology system 100 moves the sensor 120 such that the sensor 120 detects the optical signal 202 reflecting off the optical device 112. The metrology system 100 then analyzes the signals from the sensor 120 to determine reflection metrics for the optical device 112.

As seen in FIG. 2D, after the metrology system 100 finishes sensing reflected signals from the optical device 112, the metrology system 100 may move the bottom portion 106 towards the stage 102 and/or the optical device 112. By moving the bottom portion 106, the metrology system 100 positions the sensor 122 beneath the optical device 112 and between the optical device 112 and the stage 102. In some embodiments, the metrology system 100 moves the bottom portion 106 and/or the sensor 122 beneath the optical device 112 between the optical device 112 and the stage 102 before the metrology system 100 finishes sensing reflected signals from the optical device 112.

The metrology system 100 may determine from the images from the alignment camera 116 of the optical device 112 how to position the optical device 112 such that the optical device 112 transmits optical signals from the optical source 118. The metrology system 100 then moves (e.g., translates, rotates, etc.) the stage 102 and/or the optical device 112 into that position.

As seen in FIG. 2E, the metrology system 100 then directs an optical signal 204 from the optical source 118 to the optical device 112. The optical signal 204 transmits through the optical device 112 and towards the sensor 122. The metrology system 100 may move the bottom portion 106 and/or the sensor 122 so that the sensor 122 detects the optical signal 204 transmitting through the optical device 112. The metrology system 100 then analyzes the signals from the sensor 122 to determine transmission metrics for the optical device 112.

As seen in FIG. 2F, after the metrology system 100 finishes sensing transmitted signals through the optical device 112, the metrology system 100 may move the bottom portion 106 and/or the sensor 122 away from the stage 102 and/or the optical device 112. In this manner, the sensor 122 is no longer positioned between the stage 102 and the optical device 112. Additionally, the bottom portion 106 is cleared away from the stage 102. The metrology system 100 then moves the stage 102 away from or out of the metrology system 100. In the example of FIG. 2E, the metrology system 100 moves the stage 102 to the right. If the metrology system 100 had not moved the bottom portion 106 away from the stage 102 and/or the optical device 112, the bottom portion 106 would have collided with one or more of the columns 114, which would have prevented the metrology system 100 from moving the stage 102 away from or out of the metrology system 100. By moving the bottom portion 106 towards and away from the stage 102, the metrology system 100 can measure both reflection metrics and transmission metrics rather than using separate systems to measure reflection metrics and transmission metrics.

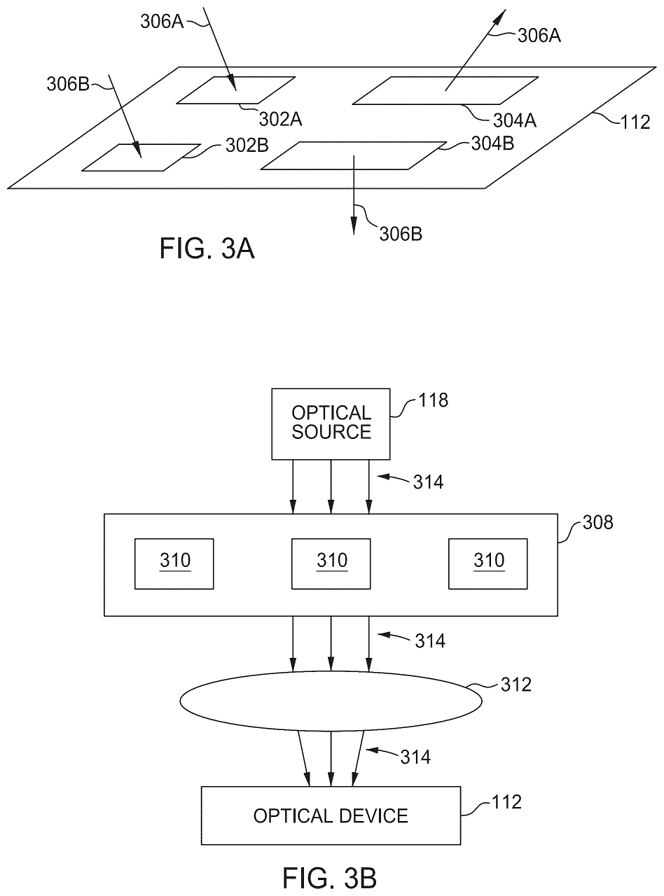

FIG. 3A illustrates an example optical device 112 in the metrology system 100 of FIG. 1. As seen in FIG. 3A, the optical device 112 includes optical couplers 302 (which may be referred to as in-couplers) and optical couplers 304 (which may be referred to as out-couplers). The optical device 112 may include any number of optical couplers 302 and 304. In the example of FIG. 3A, the optical device 112 includes the optical couplers 302A, 302B, 304A, and 304B.

When an optical signal 306A is directed at the optical coupler 302A (which may be referred to as a reflection in-coupler), the optical coupler 302A directs the optical signal 306A through the optical device 112 and out the optical coupler 304A (which may be referred to as a reflection out-coupler). If the optical signal 306A approaches the optical coupler 302A from above the optical device 112, the optical coupler 304A directs the optical signal 306A away and above the optical device 112. In this manner, the optical couplers 302A and 304A reflect the optical signal 306A. For example, when the optical source of the metrology system 100 directs an optical signal to the optical coupler 302A, the optical device 112 redirects the optical signal out of the optical coupler 304A and towards the reflection sensor in the upper portion of the metrology system 100.

When an optical signal 306B is directed at the optical coupler 302B (which may be referred to as a transmission in-coupler), the optical coupler 302B directs the optical signal 306B through the optical device 112 and out the optical coupler 304B (which may be referred to as a transmission out-coupler). If the optical signal 306B approaches the optical coupler 302B from above the optical device 112, the optical coupler 304B directs the optical signal 306B away and below the optical device 112. In this manner, the optical couplers 302B and 304B transmit the optical signal 306B. For example, when the optical source of the metrology system 100 directs an optical signal to the optical coupler 302B, the optical device 112 redirects the optical signal out of the optical coupler 304B and towards the transmission sensor in the bottom portion of the metrology system 100.

FIG. 3B illustrates an example portion of the metrology system 100 of FIG. 1. As seen in FIG. 3B, the metrology system 100 includes one or more reticle trays 308 with one or more reticles 310. The metrology system 100 also includes one or more lenses 312. The metrology system 100 positions a reticle tray 308 and a lens 312 between the optical source 118 and the optical device 112 when measuring certain reflection metrics or transmission metrics. The reticles 310 of the reticle tray 308 project certain reticle patterns or shapes towards the optical device 112 when the optical source 118 directs an optical signal 314 towards the reticle tray 308, and the lens 312 focuses or redirects optical signals 314 towards the optical device 112. Generally, different reticle patterns or shapes may make it easier to measure certain reflection metrics or transmission metrics. After the metrology system 100 has finished measuring a certain reflection metric or transmission metric, the metrology system 100 may swap the reticle tray 308 for another reticle tray 308 to project another reticle pattern or swap the lens 312 for another lens 312 to redirect or focus the optical signal 314 differently towards the optical device 112. The new reticle tray 308 or lens 312 may make it easier to measure a different reflection metric or transmission metric. The metrology system 100 may then measure this reflection metric or transmission metric.

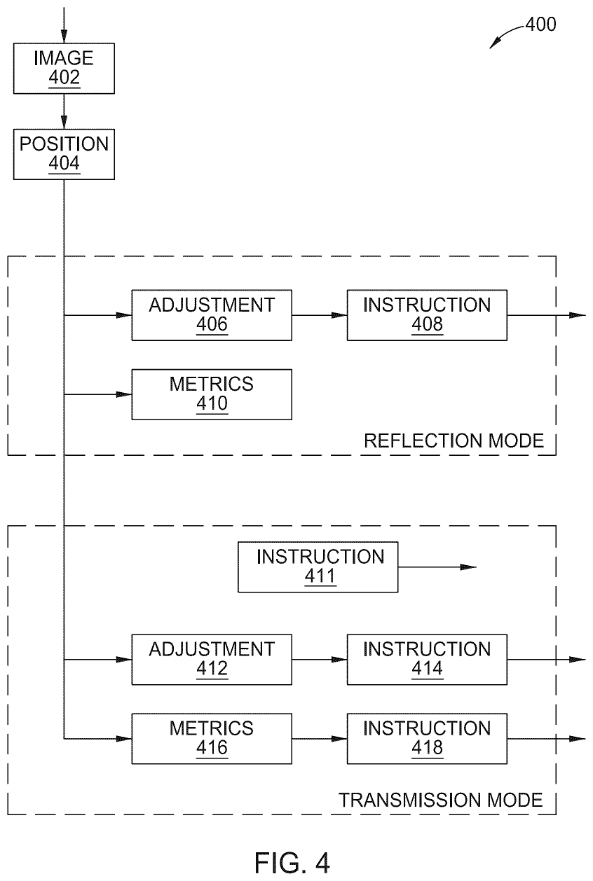

FIG. 4 illustrates an example operation 400 performed by the metrology system 100 of FIG. 1. A computer system (e.g., the computer system 108 shown in FIG. 1) may perform the operation 400. By performing the operation 400, the computer system measures reflection metrics and transmission metrics.

The computer system begins by receiving an image 402 of an optical device. The optical device may be elevated by a stage that the computer system moves into the metrology system. The computer system may use an alignment camera to capture the image 402 of the optical device. In some embodiments, the image 402 may show a fiducial (e.g., a marking, slit, cut, etc.) on the optical device. The fiducial may serve as a reference that the computer system uses to determine the position and/or orientation of the optical device relative to the alignment camera.

The computer system may operate in two modes: a reflection mode and a transmission mode. During the reflection mode, the computer system may reflect optical signals off the optical device to measure reflection metrics using a reflection sensor. During the transmission mode, the computer system may transmit optical signals through the optical device to measure transmission metrics using a transmission sensor.

In the example of FIG. 4, the computer system begins in the reflection mode. The computer system determines an adjustment 406 to the position 404 of the optical device such that an optical signal from an optical source would be directed to an optical coupler on the optical device that would cause the optical signal to be reflected off the optical device. In some embodiments, the computer system uses a known distance between the alignment camera and the optical source to determine the adjustment 406. The computer system then generates an instruction 408 and communicates the instruction 408 to move the stage elevating the optical device. The instruction 408 makes the adjustment 406 to the positioning of the stage to change the position 404 of the optical device. In this manner, the optical signal from the optical source is directed to the optical coupler of the optical device for reflecting the optical signal.

The computer system then uses the reflection sensor to detect the optical signal reflected from the optical device. The reflection sensor may be positioned above the optical device, like the alignment camera and the optical source. In some embodiments, the computer system communicates instructions that move the reflection sensor such that the reflection sensor detects the optical signal reflected from the optical device. The computer system analyzes signals from the reflection sensor to determine the metrics 410, which may be reflection metrics for the optical device.

During the transmission mode, the computer system operates the metrology system to determine transmission metrics for the optical device. The computer system may initiate the transmission mode by generating and communicating instructions 411 to move the transmission sensor towards the stage and the optical device. For example, the instructions 411 may move an arm attached to the transmission sensor towards the stage and the optical device. The computer system may move the transmission sensor such that the transmission sensor is positioned beneath the optical device between the stage and the optical device.

The computer system may initiate the transmission mode at any time after the stage has been moved into the metrology system. For example, the computer system may initiate the transmission mode after the computer system has finished measuring the metrics 410 during the reflection mode. As another example, the computer system may initiate the transmission mode during the reflection mode. As a result, the transmission mode and the reflection mode may not be mutually exclusive of each other and may overlap each other in some instances.

After positioning the transmission sensor, the computer system determines an adjustment 412 to the position 404 of the optical device. For example, the computer system may determine the adjustment 412 that would cause the optical signal from the optical source to be directed to an optical coupler on the optical device that causes the optical device to transmit the optical signal through the optical device. The computer system generates and communicates an instruction 414 to make the adjustment 412 to the position 404 of the optical device. The instruction 414 may cause the stage to move to adjust the position of the optical device elevated by the stage.

After positioning the optical device, the optical device transmits the optical signal from the optical source through the optical device and into the transmission sensor positioned beneath the optical device. In some embodiments, the computer system communicates instructions that move the transmission sensor such that the transmission sensor detects the optical signal transmitted through the optical device. The computer system analyzes signals from the transmission sensor to determine metrics 416, which may be transmission metrics for the optical device.

After the computer system finishes measuring the metrics 416, the computer system generates and communications instructions 418 that cause the transmission sensor to move away from the optical device and the stage. For example, the instructions 418 may move an arm attached to the transmission sensor away from the optical device and stage. By moving the transmission sensor away from the optical device and stage, the computer system provides clearance so that the stage does not collide with the transmission sensor and/or arm when the stage is moved away from or out of the metrology system. After moving the transmission sensor away from the optical device and stage, the computer system moves the optical device and stage away from or out of the metrology system. The computer system may then repeat the operation 400 by moving another stage and optical device into the metrology system.

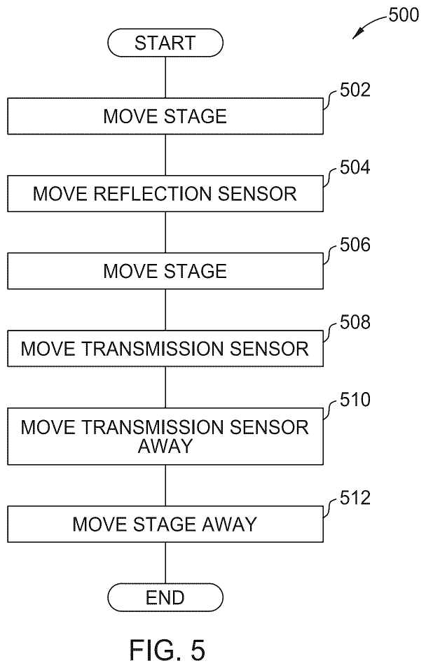

FIG. 5 is a flowchart of an example method 500 performed by the metrology system 100 of FIG. 1. In certain embodiments, a computer system (e.g., the computer system 108 shown in FIG. 1) performs the method 500. By performing the method 500, the computer system measures both reflection metrics and transmission metrics for an optical device.

At block 502, the computer system moves a stage elevating an optical device to adjust a position of the optical device. The computer system may determine the adjustment to the position of the optical device by analyzing images of the optical device from an alignment camera. The computer system may move the stage and/or the optical device such that an optical signal from an optical source is directed at an optical coupler on the optical device that causes the optical device to reflect the optical signal.

At block 504, the computer system moves a reflection sensor above the optical device such that the reflection sensor detects the optical signal reflected from the optical device. The computer system analyzes signals from the reflection sensor to measure reflection metrics for the optical device.

At block 506, the computer system moves the stage to adjust a position of the optical device. The computer system may determine the adjustment to the position of the optical device by analyzing images of the optical device from the alignment camera. The computer system may move the stage and/or the optical device such that an optical signal from the optical source is directed at an optical coupler on the optical device that causes the optical device to transmit the optical signal through the optical device.

At block 508, the computer system moves a transmission sensor into position beneath the optical device between the stage and the optical device. The transmission sensor may have been positioned away from the stage and optical device previously to provide clearance for the stage to be moved into the metrology system. By moving the transmission sensor beneath the optical device, the transmission sensor may detect the optical signal transmitted through the optical device. The computer system analyzes signals from the transmission sensor to measure transmission metrics for the optical device.

At block 510, the computer system move the transmission sensor away from the optical device and/or the stage after the computer system finishes measuring transmission metrics for the optical device. The computer system may move the arm attached to the transmission sensor away from the optical device to move the transmission sensor away from the optical device and out from between the optical device and the stage. By moving the transmission sensor away from the optical device, the computer system creates clearance to move the stage and optical device away from or out of the metrology system.

At block 512, the computer system moves the stage away from or out of the metrology system. For example, the computer system may move the stage away from the alignment camera and the optical source. In this manner, the computer system frees the metrology system to accept or receive another stage and/or optical device.

While the foregoing is directed to embodiments of the present disclosure, other embodiments of the disclosure may be devised without departing from the basic scope thereof, and the scope thereof is determined by the claims that follow.

What is claimed is:

1. A system comprising:
an optical source positioned on a first side of an optical device held by a stage;
a first sensor positioned on the first side of the optical device; and
a second sensor, wherein:
during a first mode, the first sensor detects a first optical signal from the optical source reflected from the optical device; and
during a second mode, the second sensor moves such that (i) the second sensor is positioned on a second side of the optical device opposite the first side of the optical device and (ii) the second sensor detects a second optical signal from the optical source transmitted through the optical device.

2. The system of claim 1, wherein:
after the second sensor detects the second optical signal, the second sensor moves out from between the optical device and the stage; and
the stage moves away from the optical source.

3. The system of claim 1, wherein:
the optical device comprises a reflection in-coupler and a transmission in-coupler;
during the first mode, the stage moves such that the first optical signal from the optical source is directed to the reflection in-coupler; and
during the second mode, the stage moves such that the second optical signal from the optical source is directed to the transmission in-coupler.

4. The system of claim 1, wherein:
a first reticle moves between the optical source and the optical device to measure a first metric for the optical device based on a signal from at least one of the first sensor or the second sensor;
the first reticle moves away from the optical source; and
a second reticle moves between the optical source and the optical device to measure a second metric for the optical device based on a signal from at least one of the first sensor or the second sensor.

5. The system of claim 1, wherein:
during the first mode:
the stage moves, based on one or more images of the optical device, to reposition the optical device; and
the first sensor moves such that the first sensor detects the first optical signal; and
the second sensor is positioned between the stage and the optical device when the second sensor is positioned on the second side of the optical device.

6. The system of claim 5, wherein the stage moving comprises at least one of the stage translating or rotating.

7. The system of claim 5, wherein the stage moving is based on a fiducial of the optical device appearing in the one or more images.

8. The system of claim 1, wherein the stage moving is based on a distance between an alignment camera and the optical source.

9. A method comprising:
during a first mode:
directing, by an optical source positioned on a first side of an optical device held by a stage, a first optical signal towards the optical device; and
detecting, by a first sensor positioned on the first side of the optical device, the first optical signal from the optical source reflected from the optical device; and
during a second mode:
directing, by the optical source, a second optical signal towards the optical device; and
moving a second sensor such that (i) the second sensor is positioned on a second side of the optical device opposite the first side of the optical device and (ii) the second sensor detects the second optical signal from the optical source transmitted through the optical device.

10. The method of claim 9, further comprising:
after the second sensor detects the second optical signal, moving the second sensor out from between the optical device and the stage; and
moving the stage away from the optical source.

11. The method of claim 9, wherein:
the optical device comprises a reflection in-coupler and a transmission in-coupler;
moving the stage during the first mode comprises moving the stage such that the first optical signal from the optical source is directed to the reflection in-coupler; and
moving the stage during the second mode comprises moving the stage such that the second optical signal from the optical source is directed to the transmission in-coupler.

12. The method of claim 9, further comprising:
moving a first reticle between the optical source and the optical device;
determining a first metric for the optical device based on a signal from at least one of the first sensor or the second sensor;
moving the first reticle away from the optical source;
moving a second reticle between the optical source and the optical device; and
determining a second metric for the optical device based on a signal from at least one of the first sensor or the second sensor.

13. The method of claim 9, further comprising:
during the first mode:
moving the stage, based on one or more images of the optical device, to reposition the optical device; and
moving the first sensor such that the first sensor detects the first optical signal; and
the second sensor is positioned between the stage and the optical device when the second sensor is positioned on the second side of the optical device.

14. The method of claim 13, wherein moving the stage comprises at least one of translating or rotating the stage.

15. The method of claim 13, wherein moving the stage is based on a fiducial of the optical device appearing in the one or more images.

16. The method of claim 13, wherein moving the stage is based on a distance between an alignment camera and the optical source.

17. A non-transitory computer readable medium storing instructions that, when executed by one or more processors, causes the one or more processors to, individually or collectively:
during a first mode:
direct, by an optical source positioned on a first side of an optical device held by a stage, a first optical signal towards the optical device; and
detect, by a first sensor positioned on the first side of the optical device, the first optical signal from the optical source reflected from the optical device; and
during a second mode:
direct, by the optical source, a second optical signal towards the optical device; and
move a second sensor such that (i) the second sensor is positioned on a second side of the optical device opposite the first side of the optical device and (ii) the second sensor detects the second optical signal from the optical source transmitted through the optical device.

18. The medium of claim 17, wherein the instructions further cause the one or processors to, individually or collectively:
after the second sensor detects the second optical signal, move the second sensor out from between the optical device and the stage; and
move the stage away from the optical source.

19. The medium of claim 17, wherein:
the optical device comprises a reflection in-coupler and a transmission in-coupler;
moving the stage during the first mode comprises moving the stage such that the first optical signal from the optical source is directed to the reflection in-coupler; and
moving the stage during the second mode comprises moving the stage such that the second optical signal from the optical source is directed to the transmission in-coupler.

20. The medium of claim 17, wherein the instructions further cause the one or processors to, individually or collectively:
move a first reticle between the optical source and the optical device;
determine a first metric for the optical device based on a signal from at least one of the first sensor or the second sensor;
move the first reticle away from the optical source;
move a second reticle between the optical source and the optical device; and
determine a second metric for the optical device based on a signal from at least one of the first sensor or the second sensor.
